(19) United States
(12) Patent Application Publication
(10) Pub. No.: US 2022/0101178 A1
(43) Pub. Date: Mar. 31, 2022

(54) ADAPTIVE DISTRIBUTED LEARNING MODEL OPTIMIZATION FOR PERFORMANCE PREDICTION UNDER DATA PRIVACY CONSTRAINTS

(71) Applicant: EMC IP Holding Company LLC, Hopkinton, MA (US)

(72) Inventors: Pablo Nascimento Da Silva, Niterói (BR); Paulo Abeiha Ferreira, Rio de Janeiro (BR); Tiago Salviano Calmon, Rio de Janeiro (BR); Vinicius Michel Gottin, Rio de Janeiro (BR); Roberto Nery Stelling Neto, Rio de Janeiro (BR)

(21) Appl. No.: 17/032,515

(22) Filed: Sep. 25, 2020

(51) Int. Cl. G06N 20/00; G06K 9/62; G06F 11/34; G06F 21/62

(52) U.S. Cl. CPC G06N 20/00; G06K 9/6256; G06F 21/6245; G06F 11/3409; G06K 9/6215

(57) ABSTRACT

An adaptive distributed learning model optimization for performance prediction under data privacy constraints. Specifically, the disclosed method and system introduce a framework through which a shared machine learning model deployed across a network of computing nodes may be optimized using private and decentralized datasets. Through the proposed framework, the shared machine learning model may achieve a good generalization error globally across the network, and may also achieving good predictive performance locally while employed on each computing node.

### BACKGROUND

Through the framework of federated learning, a network-shared machine learning model may be trained using decentralized data stored on various client devices, in contrast to the traditional methodology of using centralized data maintained on a single, central device.

### SUMMARY

In general, in one aspect, the invention relates to a method for adaptive distributed learning model optimization. The method includes receiving, by a worker node and from a central node, a first learning model configured with an initial learning state, making a first determination that a first data shift has transpired, issuing, based on the first determination, a first data shift notice to the central node, receiving, in response to issuing the first data shift notice, a first data shift instruction from the central node, and adjusting, based on the first data shift instruction, the initial learning state through optimization of the first learning model using local data to obtain a second learning model configured with local data adjusted learning state.

In general, in one aspect, the invention relates to a non-transitory computer readable medium (CRM). The non-transitory CRM includes computer readable program code, which when executed by a computer processor on a worker node, enables the computer processor to receive, from a central node, a first learning model configured with an initial learning state, make a first determination that a first data shift has transpired, issue, based on the first determination, a first data shift notice to the central node, receive, in response to issuing the first data shift notice, a first data shift instruction from the central node, and adjust, based on the first data shift instruction, the initial learning state through optimization of the first learning model using local data to obtain a second learning model configured with local data adjusted learning state.

Other aspects of the invention will be apparent from the following description and the appended claims.

### BRIEF DESCRIPTION OF DRAWINGS

FIG. 1A shows a system in accordance with one or more embodiments of the invention.

FIG. 1B shows a worker node in accordance with one or more embodiments of the invention.

FIG. 1C shows a central node in accordance with one or more embodiments of the invention.

FIG. 2 shows a flowchart describing a method for adaptive distributed learning model optimization for performance prediction under data privacy constraints in accordance with one or more embodiments of the invention.

FIG. 3 shows a flowchart describing a method for data shift detection in accordance with one or more embodiments of the invention.

FIG. 4 shows a flowchart describing a method for adaptive distributed learning model optimization for performance prediction under data privacy constraints in accordance with one or more embodiments of the invention.

FIG. 5 shows an exemplary computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

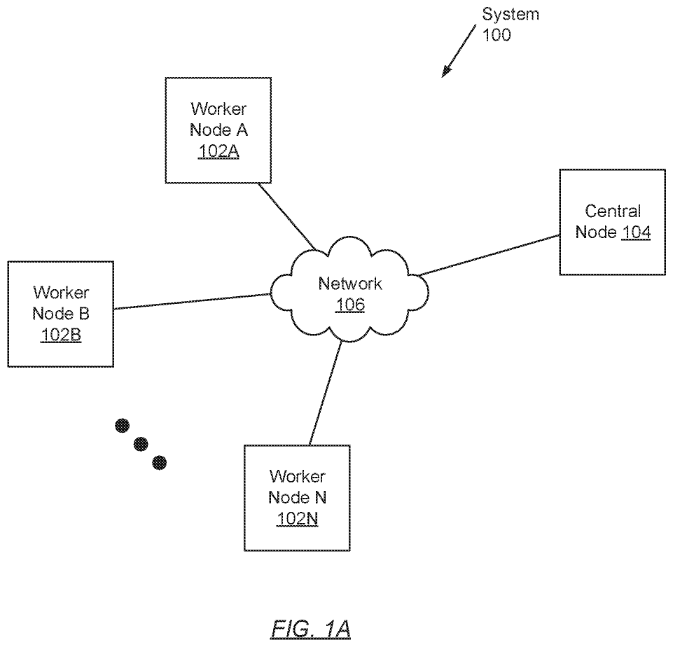

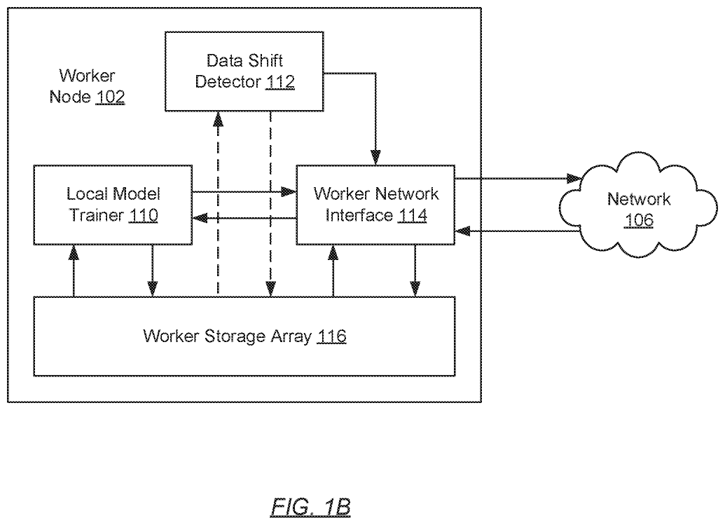

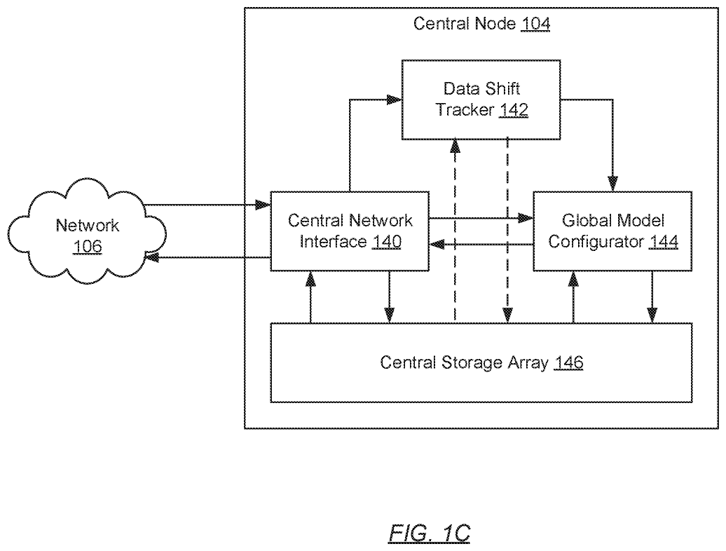

In the following description of FIGS. 1A-5, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to an adaptive distributed learning model optimization for performance prediction under data privacy constraints. Specifically, one or more embodiments of the invention introduce a framework through which a shared machine learning model deployed across a network of computing nodes may be optimized using private and decentralized datasets. Through the proposed framework, the shared machine learning model may achieve a good generalization error globally across the network, and may also achieving good predictive performance locally while employed on each computing node.

FIG. 1A shows a system in accordance with one or more embodiments of the invention. The system (100) may represent an enterprise information technology (IT) infrastructure domain, which may entail composite hardware, software, and networking resources, as well as services, directed to the implementation, operation, and management thereof. The system (100) may include, but is not limited to, two or more worker nodes (102A-102N) operatively connected to a central node (104) through a network (106). Each of these system (100) components is described below.

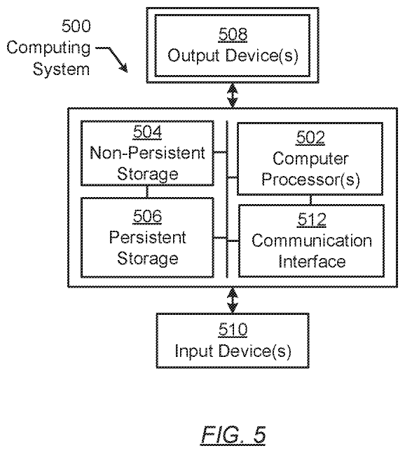

In one embodiment of the invention, a worker node (102A-102N) may represent any physical appliance or computing system configured to receive, generate, process, store, and/or transmit data, as well as to provide an environment in which one or more computer programs may execute thereon. The computer program(s) may, for example, implement large-scale and complex data processing; or implement one or more services offered locally or over the network (106). Further, any subset of the computer program(s) may employ or invoke machine learning and/or artificial intelligence to perform their respective functions and, accordingly, may participate in federated learning (described below). In providing an execution environment for the computer program(s) installed thereon, a worker node (102A-102N) may include and allocate various resources (e.g., computer processors, memory, storage, virtualization, networking, etc.), as needed, to the computer program(s) and the tasks instantiated thereby. One of ordinary skill will appreciate that a worker node (102A-102N) may perform other functionalities without departing from the scope of the invention. Examples of a worker node (102A-102N) may include, but are not limited to, a desktop computer, a workstation computer, a server, a mainframe, a mobile device, or any other computing system similar to the exemplary computing system shown in FIG. 5. Worker nodes (102A-102N) are described in further detail below with respect to FIG. 1B.

In one embodiment of the invention, federated learning may refer to the optimization (i.e., training and/or validation) of machine learning or artificial intelligence models using decentralized data. In traditional learning methodologies, the training and/or validation data, pertinent for optimizing learning models, are often stored centrally on a single device, datacenter, or the cloud. Under some circumstances, however, such as scenarios wherein data restriction constraints or data privacy regulations are observed, the hoarding (or accessing) of all data at (or from) a single location is an unethical violation, and therefore, becomes infeasible. In such scenarios, federated learning may be tapped for learning model optimization without depending on the direct access of restricted or private data. That is, through federated learning, the training and/or validation data may be stored across various devices (i.e., worker nodes (102A-102N))—with each device performing a local optimization of a shared learning model using their respective local data. Thereafter, updates to the shared learning model, derived differently on each device based on different local data, may subsequently be forwarded to a federated learning coordinator (i.e., central node (104)), which aggregates and applies the updates to improve the shared learning model.

In one embodiment of the invention, an above-mentioned learning model may generally refer to a machine learning and/or artificial intelligence algorithm configured for classification and/or prediction applications. A learning model may further encompass any learning algorithm capable of self-improvement through the processing of sample (e.g., training and/or validation) data. Examples of a learning model may include, but are not limited to, a neural network, a support vector machine, and a decision tree.

In one embodiment of the invention, at least one of the learning models, deployed on any subset or all of the worker nodes (102A-102N), may be purposed with predicting one or more metrics directed to worker node storage array performance. Inputs for such a learning model, from which the performance metric(s) (or output(s)) may be derived, may include, but are not limited to, current and/or historical telemetry and configuration information. The telemetry may encompass various, periodically monitored properties or variables (examples below) describing the environmental and/or operational state of the local worker storage array (see e.g., FIG. 1B). The configuration information, on the other hand, may disclose various parameters (examples below) detailing the hardware, software, and/or firmware components installed on the local worker node (102A-102N). Lastly, the performance metric(s), derived by such a learning model, may include, but are not limited to: storage disk throughput, storage disk rotational latency, data read and/or write response times, average data seek time, storage disk transfer rate, over-provisioning ratio, data deduplication and/or compression ratio, and other storage related performance metrics.

Examples of the above-mentioned telemetry may include, but are not limited to: allocated and utilized storage space size(s) for one or more logical unit number(s) (LUN), allocated and utilized metadata storage space size(s) for one or more LUNs, snapshot storage space size(s) for one or more LUNs, total number of input-output (IO) operations for one or more virtual disks, current and maximum number of IO operations per second (IOPS) for one or more virtual disks, current and maximum disk speed for one or more virtual disks, read and cache hit percentages for one or more virtual disks, the current mode (e.g., unassigned, assigned, hot spare standby, hot spare in use) of one or more physical disks, and the current status (e.g., optimal, failed, replaced, pending failure, none/undefined) of one or more physical disks.

Furthermore, examples of the above-mentioned configuration information may include, but are not limited to: basic input-output system (BIOS) settings (e.g. system memory size, system memory type, system memory speed, memory operating mode, computer processor architecture, computer processor speed, system bus speed, storage device capacity, storage device types, boot sequence, BIOS build date, BIOS version number, etc.), storage redundant array of independent disks (RAID) settings (e.g., RAID level, storage disk size, storage disk model, storage disk status, maximum number of storage disks per array, storage stripe or block size, etc.), and network interface card or controller (NIC) settings (e.g., Internet Protocol (IP) address source, IP address, default gateway IP address, subnet mask, domain name system (DNS) address source, DNS IP address, device model, device firmware version, etc.).

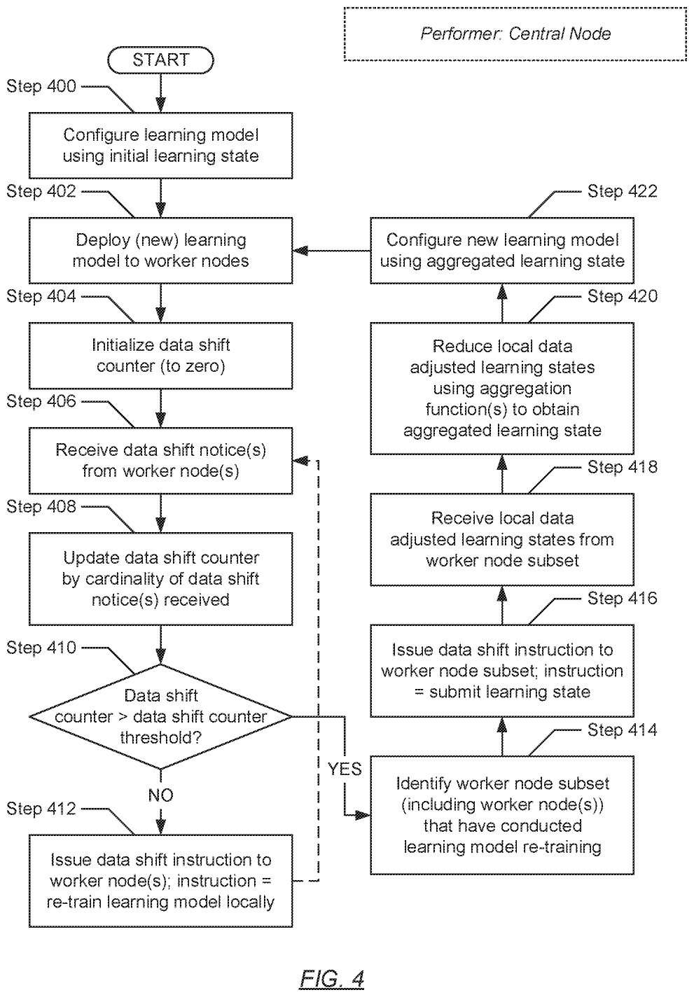

In one embodiment of the invention, the central node (104) may represent any physical appliance or computing system configured for federated learning (described above) coordination. By federated learning coordination, the central node (104) may include functionality to perform the various steps of the method described in FIG. 4, below. Further, one of ordinary skill will appreciate that the central node (104) may perform other functionalities without departing from the scope of the invention. Moreover, the central node (104) may be implemented using one or more servers (not shown). Each server may represent a physical or virtual server, which may reside in a datacenter or a cloud computing environment. Additionally or alternatively, the central node (104) may be implemented using one or more computing systems similar to the exemplary computing system shown in FIG. 5. The central node (104) is described in further detail below with respect to FIG. 1C.

In one embodiment of the invention, the above-mentioned system (100) components may operatively connect to one another through the network (106) (e.g., a local area network (LAN), a wide area network (WAN) such as the Internet, a mobile network, any other network type, or a combination thereof). The network (106) may be implemented using any combination of wired and/or wireless connections. Further, the network (106) may encompass various interconnected, network-enabled subcomponents (or systems) (e.g., switches, routers, gateways, etc.) that may facilitate communications between the above-mentioned system (100) components. Moreover, the above-mentioned system (100) components may communicate with one another using any combination of wired and/or wireless communication protocols.

While FIG. 1A shows a configuration of components, other system (100) configurations may be used without departing from the scope of the invention. For example, the system (100) may include additional central nodes (not shown) operatively connected, via the network (106), to the worker nodes (102A-102N). These additional central nodes may be deployed for redundancy.

FIG. 1B shows a worker node in accordance with one or more embodiments of the invention. The worker node (102) may include, but is not limited to, a local model trainer (110), a data shift detector (112), a worker network interface (114), and a worker storage array (116). Each of these worker node (102) subcomponents is described below.

In one embodiment of the invention, the local model trainer (110) may refer to a computer program that may execute on the underlying hardware of the worker node (102). Specifically, the local model trainer (110) may be responsible for optimizing (i.e., training and/or validating) one or more learning models (described above). To that extent, for any given learning model, the local model trainer (110) may include functionality to: select local data (described below) pertinent to the given learning model from the worker storage array (116); and process the selected local data using the given learning model to adjust learning state (described below) of, and thereby optimize, the given learning model. Further, the local model trainer (110) may be triggered to perform the aforementioned functionalities upon instruction from the central node (described above) (see e.g., FIG. 1A) following the detection of any data shift amongst the local data maintained in the worker storage array (116). For any given learning model, the local model trainer (110) may include further functionality to: submit, via the worker network interface (114), local data adjusted learning state (described below) to the central node upon alternative instruction. Moreover, one of ordinary skill will appreciate that the local model trainer (110) may perform other functionalities without departing from the scope of the invention.

In one embodiment of the invention, the above-mentioned local data (which may be stored in the worker storage array (116)) may, for example, include one or more collections of data—each representing tuples of feature-target data pertinent to optimizing a given learning model (not shown) deployed on the worker node (102). Each feature-target tuple, of any given data collection, may refer to a finite ordered list (or sequence) of elements, including: a feature set; and one or more expected (target) classification or prediction values. The feature set may refer to an array or vector of values (e.g., numerical, categorical, etc.)—each representative of a different feature (i.e., measurable property or indicator) significant to the objective or application of the given learning model, whereas the expected classification/prediction value(s) (e.g., numerical, categorical, etc.) may each refer to a desired output of, upon processing of the feature set by, the given learning model.

In one embodiment of the invention, the above-mentioned learning state may refer to one or more factors pertinent to the automatic improvement (or “learning”) of a learning model through experience—e.g., through iterative optimization using various sample training and/or validation data. The aforementioned factor(s) may differ depending on the design, configuration, and/or operation of the learning model. For a neural network based learning model, for example, the factor(s) may include, but is/are not limited to: weights representative of the connection strengths between pairs of nodes structurally defining the neural network; weight gradients representative of the changes or updates applied to the weights during optimization based on output error of the neural network; and/or a weight gradients learning rate defining the speed at which the neural network updates the weights. Further, the above-mentioned local data adjusted learning state may represent learning state optimized based on or derived from any subset of local data stored in the worker storage array (116).

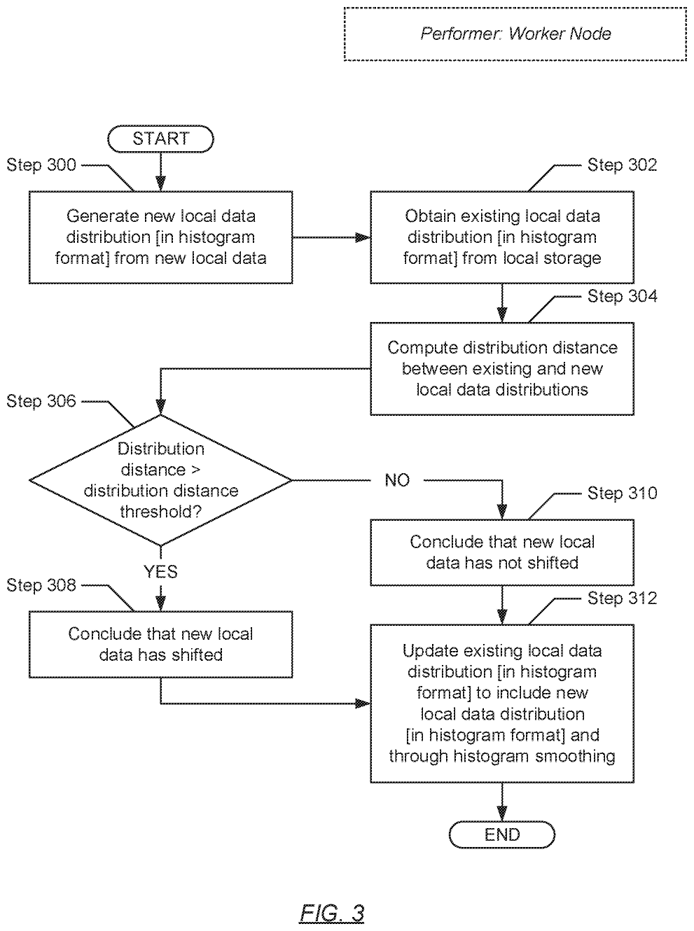

In one embodiment of the invention, the data shift detector (112) may refer to a computer program that may execute on the underlying hardware of the worker node (102). Specifically, the data shift detector (112) may be responsible for detecting data shifts amongst local data collected and stored in the worker storage array (116). A data shift may refer to a significant change in learning model input (or feature set) distribution, which may be introduced through the collection of new local data divergent to the existing, stored local data. By way of an example, a data shift (and thus, a detection thereof) may transpire when the format of new, collected local data (e.g., image and/or video objects) substantially differs from the format of the existing, stored local data (e.g., text documents). One of ordinary skill will appreciate that embodiments of the invention is not limited to the aforementioned data shift example. To the extent of detecting data shifts, the data shift detector (112) may include functionality to perform the various steps of the method described in FIG. 3, below. Furthermore, one of ordinary skill will appreciate that the data shift detector (112) may perform other functionalities without departing from the scope of the invention.

In one embodiment of the invention, the worker network interface (114) may refer to networking hardware (e.g., network card or adapter), a logical interface, an interactivity protocol, or any combination thereof, which may be responsible for facilitating communications between the worker node (102) and at least the central node (not shown) via the network (106). To that extent, the worker network interface (114) may include functionality to: receive learning models (shared via federated learning) from the central node; provide the learning models to, for invocation by, classification and/or prediction purposed computer programs (not shown) and to, for optimization by, the local model trainer (110); transmit data shift notices to the central node should data shifts be detected by the data shift detector (112); receive, in response to issued data shift notices, data shift instructions from the central node; provide the data shift instructions to the local model trainer (110) for processing; receive local data adjusted learning state(s) for one or more learning models from the local model trainer (110); and transmit the local data adjusted learning state(s) to the central node in response to the received data shift instructions. Moreover, one of ordinary skill will appreciate that the worker network interface (114) may perform other functionalities without departing from the scope of the invention.

In one embodiment of the invention, the worker storage array (116) may refer to a collection of one or more physical storage devices (not shown) on which various forms of data—e.g., local data (i.e., input and target data) (described above) pertinent to the training and/or validation of learning models, local data adjusted learning state(s) (described above) for one or more learning models, existing and new local data distributions (in histogram formats) (described below) (see e.g., FIG. 3), etc.—may be consolidated. Each physical storage device may encompass non-transitory computer readable storage media on which data may be stored in whole or in part, and temporarily or permanently. Further, each physical storage device may be implemented based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the worker storage array (116) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

While FIG. 1B shows a configuration of subcomponents, other worker node (102) configurations may be used without departing from the scope of the invention.

FIG. 1C shows a central node in accordance with one or more embodiments of the invention. The central node (104) may include, but is not limited to, a central network interface (140), a data shift tracker (142), a global model configurator (144), and a central storage array (146). Each of these central node (104) subcomponents is described below.

In one embodiment of the invention, the central network interface (140) may refer to networking hardware (e.g., network card or adapter), a logical interface, an interactivity protocol, or any combination thereof, which may be responsible for facilitating communications between the central node (104) and one or more worker nodes (not shown) via the network (106). To that extent, the central network interface (140) may include functionality to: obtain learning models from the global model trainer (144); deploy (i.e., transmit) the obtained learning models to the worker node(s) for use, as well as for optimization (i.e., training and/or validation) using local data thereon; receive data shift notices from the worker node(s); provide the received data shift notices to the data shift tracker (142) for processing; obtain data shift instructions from the global model configurator (144); transmit the obtained data shift instructions to the worker node(s); in response to transmitting a particular type of data shift instruction (i.e., submit learning state), receive local data adjusted learning state(s) (described above) (see e.g., FIG. 1B) from the worker node(s); and provide the received local data adjusted learning state(s) to the global model configurator (144) for processing. Further, one of ordinary skill will appreciate that the central network interface (140) may perform other functionalities without departing from the scope of the invention.

In one embodiment of the invention, the data shift tracker (142) may refer to a computer program that may execute on the underlying hardware of the central node (104). Specifically, the data shift tracker (142) may be responsible for the recordation of data shifts detected across one or more worker nodes. To that extent, the data shift tracker (142) may include functionality to: maintain a data shift counter reflecting a number of worker nodes that have submitted data shift notices to the central node (104); make a determination whether the data shift counter has exceeded a preset data shift counter threshold; and notify the global model configurator (144) of the determination. Further, one of ordinary skill will appreciate that the data shift tracker (142) may perform other functionalities without departing from the scope of the invention.

In one embodiment of the invention, the global model configurator (144) may refer to a computer program that may execute on the underlying hardware of the central node (104). Specifically, the global model configurator (144) may be responsible for learning state aggregation and global learning model initialization and improvement. To that extent, the global model configurator (144) may include functionality to: derive (or otherwise obtain) learning state(s) (e.g., initial learning state, aggregated learning state, etc.); configure one or more learning models using/with the derived learning state(s); provide the configured learning model(s) to the central network interface (140) for deployment to one or more worker nodes; and issue data shift instructions, via the central network interface (140), to the worker node(s). Further, one of ordinary skill will appreciate that the global model configurator (144) may perform other functionalities without departing from the scope of the invention.

In one embodiment of the invention, the central storage array (146) may refer to a collection of one or more physical storage devices (not shown) on which various forms of data—e.g., various learning states (described above) (see e.g., FIG. 1B) (e.g., initial, local data adjusted, aggregated, etc.) for one or more learning models, worker node identification and/or networking information, etc.—may be consolidated. Each physical storage device may encompass non-transitory computer readable storage media on which data may be stored in whole or in part, and temporarily or permanently. Further, each physical storage device may be implemented based on a common or different storage device technology—examples of which may include, but are not limited to, flash based storage devices, fibre-channel (FC) based storage devices, serial-attached small computer system interface (SCSI) (SAS) based storage devices, and serial advanced technology attachment (SATA) storage devices. Moreover, any subset or all of the central storage array (146) may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

While FIG. 1C shows a configuration of subcomponents, other central node (104) configurations may be used without departing from the scope of the invention.

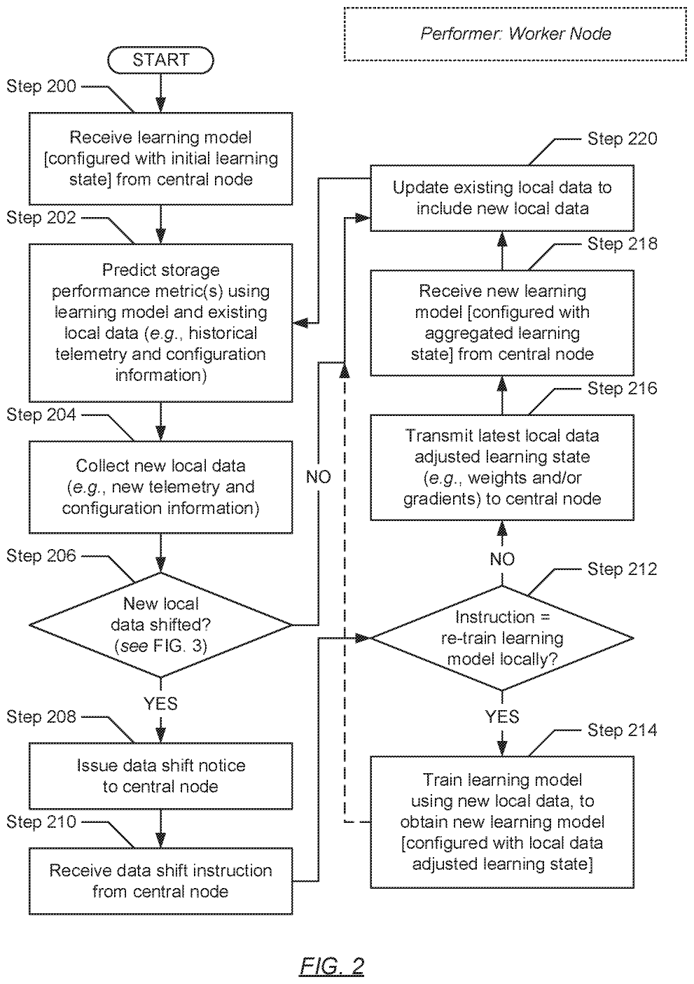

FIG. 2 shows a flowchart describing a method for adaptive distributed learning model training for performance prediction under data privacy constraints in accordance with one or more embodiments of the invention. The various steps outlined below may be performed by any worker node (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, a learning model is received from the central node (see e.g., FIG. 1A). In one embodiment of the invention, the learning model may represent a machine learning and/or artificial intelligence algorithm configured for storage array performance prediction, and may, for example, take form as a neural network, a support vector machine, a decision tree, or any other machine learning and/or artificial intelligence paradigm. Further, the learning model may be configured with an initial learning state. The initial learning state may encompass default value(s) for one or more factors (e.g., weights, weight gradients, and/or weight gradient learning rates) pertinent to the automatic improvement (or “learning”) of the learning model through experience.

In Step 202, one or more storage array performance metrics is/are predicted using the learning model (received in Step 200 or Step 218 (described below)). In one embodiment of the invention, the learning model may process feature sets (described above) (see e.g., FIG. 1B) of existing local data, previously collected and stored on the worker node, to derive the prediction(s). Each feature set may encompass storage array telemetry and/or worker node configuration information—examples of which may be found in the description of FIG. 1A, above. Examples of the predicted storage array performance metric(s) may also be found in the description of FIG. 1A, above. Furthermore, the predicted storage array performance metric(s) may subsequently be utilized in the more efficient design, production, and/or operation of one or more storage arrays.

In Step 204, new local data (entailing at least one or more new feature sets) is collected. In one embodiment of the invention, the new local data may include, but is not limited to, recent measurements for one or more periodically monitored storage array telemetry variables, and recent changes to worker node configuration state.

In Step 206, a determination is made as to whether the new local data (collected in Step 204) exhibits a data shift. A data shift may refer to a significant change in learning model input (or feature set) distribution. Accordingly, the determination may entail existing local data versus new local data distribution analysis, which is described in further detail through the flowchart in FIG. 3, below. In one embodiment of the invention, following the aforementioned analysis, if it is determined that a data shift amongst the local data has transpired, then the process proceeds to Step 208. On the other hand, in another embodiment of the invention, following the aforementioned analysis, if it is alternatively determined that a data shift amongst the local data has not occurred, then the process alternatively proceeds to Step 220.

In Step 208, following the determination (in Step 206) that a data shift amongst the local data has transpired, a data shift notice is issued to the central node. In response to the data shift notice (issued in Step 208), in Step 210, a data shift instruction is received from the central node. In one embodiment of the invention, the data shift instruction may command the worker node to re-optimize (i.e., train and/or validate) the learning model thereon using their local data (including the new local data (collected in Step 204)). In another embodiment of the invention, the data shift instruction may command the worker node to submit the latest learning state of the learning model thereon to the central node.

In Step 212, a determination is made as to whether the data shift instruction (received in Step 210) commands the worker node to re-optimize the learning model thereon. Accordingly, in one embodiment of the invention, if it is determined that the data shift instruction is indeed directed to re-optimizing the learning model on the worker node, then the process proceeds to Step 214. On the other hand, in another embodiment of the invention, if it is alternatively determined that the data shift instruction is otherwise directing the worker node to submit their latest learning model learning state, then the process alternatively proceeds to Step 216.

In Step 214, following the determination (in Step 212) that the data shift instruction (received in Step 210) is directed to re-optimizing the learning model on the worker node, the learning model (received in Step 200, obtained in a previous iteration of Step 214, or received in Step 218) is re-optimized using the new local data (collected in Step 204). Specifically, in one embodiment of the invention, the new local data may be partitioned into two data subsets. Thereafter, the learning model may be trained using a first data subset of the new local data (i.e., a learning model training set), which may result in the optimization of one or more learning model parameters. A learning model parameter may refer to a model configuration variable that may be adjusted (or optimized) during a training runtime (or epoch) of the learning model. By way of examples, learning model parameters, pertinent to a neural network based learning model, may include, but are not limited to: the weights representative of the connection strengths between pairs of nodes structurally defining the model; and the weight gradients representative of the changes or updates applied to the weights during optimization based on the output error of the neural network.

Following the above-mentioned training stage, the learning model may subsequently be validated using a second data subset of the new local data (i.e., a learning model testing set), which may result in the optimization of one or more learning model hyper-parameters. A learning model hyper-parameter may refer to a model configuration variable that may be adjusted (or optimized) before or between training runtimes (or epochs) of the learning model. By way of examples, learning model hyper-parameters, pertinent to a neural network based learning model, may include, but are not limited to: the number of hidden node layers and, accordingly, the number of nodes in each hidden node layer, between the input and output layers of the model; the activation function(s) used by the nodes of the model to translate their respective inputs to their respective outputs; and the weight gradients learning rate defining the speed at which the neural network updates the weights.

In one embodiment of the invention, adjustments to the learning state, through the above-described manner, may transpire until the learning model training and testing sets are exhausted, a threshold number of training runtimes (or epochs) is reached, or an acceptable performance condition (e.g., threshold accuracy, threshold convergence, etc.) is met. Furthermore, following these adjustments, local data adjusted learning state may be obtained, which may represent learning state optimized based on (or using) the new local data (collected in Step 204). Accordingly, a new learning model, configured with the local data adjusted learning state, may be obtained. The new learning model may be of the same paradigm (e.g., neural network, support vector machine, decision tree, etc.) as that of the learning model (received in Step 200). Hereinafter, the process proceeds to Step 220 (described below).

In Step 216, following the determination (in Step 212) that the data shift instruction (received in Step 210) is alternatively directed to learning state submission, a latest learning state (with which the learning model on the worker node is configured) is transmitted to the central node. In one embodiment of the invention, the latest learning state may encompass a most recent local data adjusted learning state (i.e., learning state optimized based on or using new local data), which may have been obtained in a previous iteration of the disclosed method (under Step 214) (described above).

In Step 218, following submission of the latest learning state (in Step 216), a new learning model is received from the central node. In one embodiment of the invention, the new learning model may be of the same paradigm (e.g., neural network, support vector machine, decision tree, etc.) as that of the learning model (received in Step 200). Further, the new learning model may be configured using/with aggregated learning state, which may encompass non-default values for one or more factors (e.g., weights, weight gradients, and/or weight gradients learning rate) pertinent to the automatic improvement (or “learning”) of the learning model through experience. These non-default values may be derived from the computation of summary statistics (e.g., averaging) on the different latest local data adjusted learning state, received by the central node, from various worker nodes (see e.g., FIG. 4).

In Step 220, existing local data (on the worker node) is updated to include the new local data (collected in Step 204). In one embodiment of the invention, this step may occur subsequent to training and/or validating the learning model (in Step 214). In another embodiment of the invention, this step may transpire following the determination (in Step 206) that a data shift amongst the local data has not transpired. In yet another embodiment of the invention, this step may take place after receiving a new learning model configured using/with aggregated learning state (in Step 216). Moreover, hereinafter, the process proceeds to Step 202, where one or more storage array performance metrics is/are predicted through processing of the existing local data (updated in Step 220).

FIG. 3 shows a flowchart describing a method for data shift detection in accordance with one or more embodiments of the invention. The various steps outlined below may be performed by any worker node (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a new local data distribution is generated. In one embodiment of the invention, the new local data distribution may represent an empirical distribution of new local data that had been collected on and by the worker node (see e.g., FIG. 2, Step 204). The new local data may include, but is not limited to, recent measurements for one or more periodically monitored storage array telemetry variables, and recent changes to worker node configuration state. Further, the new local data distribution may be expressed as a histogram plot of new local data values.

In Step 302, an existing local data distribution is obtained. In one embodiment of the invention, the existing local data distribution may represent an empirical distribution of existing (i.e., historical) local data stored on the worker node. The existing local data may include, but is not limited to, previously collected measurements for one or more periodically monitored storage array telemetry variables, as well as previously maintained worker node configuration state. Furthermore, the existing local data distribution may be expressed (and accordingly, may have been stored) as a histogram plot of existing local data values.

In Step 304, a distribution distance, between the new local data distribution (generated in Step 300) and the existing local data distribution (obtained in Step 302), is computed. In one embodiment of the invention, the distribution distance may be computed using any existing algorithm that evaluates the difference between a pair of datasets such as, for example, the maximum mean discrepancy (MMD) algorithm or the Wasserstein distance algorithm.

In Step 306, a determination is made as to whether the distribution distance (computed in Step 304) exceeds a predefined distribution distance threshold. The predefined distribution threshold may be assigned a distribution distance value consistent with the employed difference evaluation method, and accepted by ones of ordinary skill. Accordingly, in one embodiment of the invention, if it is determined that the new local data and existing local data distributions are sufficiently different based on the distribution distance exceeding the predefined distribution distance threshold, then the process proceeds to Step 308. On the other hand, in another embodiment of the invention, if it is alternatively determined that the new local data and existing local data distributions are not different enough based on the distribution distance falling short of the predefined distribution distance threshold, then the process alternatively proceeds to Step 310.

In Step 308, following the determination (in Step 306) that the distribution distance (computed in Step 304) exceeds the predefined distribution distance threshold, it is concluded that a data shift has occurred. A data shift may refer to a significant change in learning model input (or feature set) distribution. By way of an example, a data shift (and thus, a detection thereof) may transpire when the format of new, collected local data (e.g., image and/or video objects) substantially differs from the format of the existing, stored local data (e.g., text documents). Hereinafter, the process proceeds to Step 312 (described below).

In Step 310, following the alternative determination (in Step 306) that the distribution distance (computed in Step 304) falls short of the predefined distribution distance threshold, it is alternatively concluded that a data shift has not occurred. That is, by way of the above-mentioned example, the format of new, collected local data (e.g., text documents) fails to substantially differ from the format of the existing, stored local data (e.g., text documents).

In Step 312, following either conclusion that a data shift has been detected (in Step 308) or has not been detected (in Step 310), the existing local data distribution (obtained in Step 302) is updated. Specifically, in one embodiment of the invention, the new local data distribution (generated in Step 300) may be incorporated into the existing local data distribution, thereby deriving an updated existing local data distribution. Derivation of the updated existing local data distribution may employ any existing smoothing technique for histogram-valued time-series such as, for example, the exponential smoothing histogram composition method. Further, the updated existing local data distribution may be stored (thus replacing the existing local data distribution) on the worker node storage array (see e.g., FIG. 1B) in histogram format.

FIG. 4 shows a flowchart describing a method for adaptive distributed learning model training for performance prediction under data privacy constraints in accordance with one or more embodiments of the invention. The various steps outlined below may be performed by a central node (see e.g., FIGS. 1A and 1C). Further, while the various steps in the flowchart are presented and described sequentially, one of ordinary skill will appreciate that some or all steps may be executed in different orders, may be combined or omitted, and some or all steps may be executed in parallel.

Turning to FIG. 4, in Step 400, a learning model is configured. In one embodiment of the invention, the learning model may represent a machine learning and/or artificial intelligence algorithm configured for storage array performance prediction, and may, for example, take form as a neural network, a support vector machine, a decision tree, or any other machine learning and/or artificial intelligence paradigm. Further, the learning model may be configured with an initial learning state. The initial learning state may encompass default value(s) for one or more factors (e.g., weights, weight gradients, and/or weight gradient learning rates) pertinent to the automatic improvement (or “learning”) of the learning model through experience.

In Step 402, the learning model (configured in Step 400) or the new learning model (configured in Step 422) (described below) is deployed to various worker nodes. Thereafter, in Step 404, a data shift counter is initialized (i.e., to zero). In one embodiment of the invention, the data shift counter may be implemented as a hardware register, a memory-backed software numerical variable, any other device or mechanism through which a count of transpired data shifts across a network may be tracked, or any combination thereof.

In Step 406, one or more data shift notices is/are received from one or more worker nodes, respectively. In one embodiment of the invention, a data shift notice may represent a message, from a given worker node, indicating that a data shift amongst the local data on the given worker node has been detected thereon. A data shift may refer to a significant change in learning model input (or feature set) distribution. Further, a data shift notice may include identification information (e.g., unique node identifier, Internet Protocol (IP) address, etc.) associated with or assigned to the given worker node within a network.

In Step 408, the data shift counter (initialized in Step 404 or updated in a previous iteration of Step 408) is updated. Specifically, in one embodiment of the invention, the count value reflected by the data shift counter may be incremented by the cardinality (or number) of data shift notices (received in Step 406).

In Step 410, a determination is made as to whether the data shift counter (or more specifically, the count value reflected by the data shift counter) meets or exceeds a predefined data shift counter threshold. The predefined data shift counter threshold may be assigned a numerical value equivalent to a certain percentage (e.g., 5%) of the total number of worker nodes to which the learning model had been deployed (in Step 402). Accordingly, in one embodiment of the invention, if it is determined that the data shift counter meets or exceeds the predefined data shift counter threshold, then the process proceeds to Step 414. On the other hand, in another embodiment of the invention, if it is alternatively determined that the data shift counter falls short of the predefined data shift counter threshold, then the process alternatively proceeds to Step 412.

In Step 412, following the determination (in Step 410) that the data shift counter (updated in Step 408) falls below the predefined data shift counter threshold, one or more data shift instructions is/are issued to the worker node(s), respectively, from which the data shift notice(s) had been received (in Step 406). In one embodiment of the invention, each data shift instruction may direct a worker node to re-optimize (i.e., re-train and/or re-validate) the learning model (deployed thereto in Step 402) using the local data thereon. Hereinafter, the process proceeds to Step 406, where one or more additional data shift notices may be received from one or more worker nodes, respectively.

In Step 414, following the alternative determination (in Step 410) that the data shift counter (updated in Step 408) meets/exceeds the predefined data shift counter threshold, a worker node subset is identified. In one embodiment of the invention, the worker node subset may represent a group of worker nodes from which data shift notices have been received (in Step 406) since initialization of the data shift counter (in Step 404). The worker node subset may further represent a group of worker nodes to which data shift instructions, directing the worker nodes to re-optimize their respective learning models thereon using their respective local data, have been issued (in previous iterations (if any) of Step 412).

In Step 416, a data shift instruction is issued to each worker node of the worker node subset (identified in Step 414). In one embodiment of the invention, the data shift instruction may direct a worker node to submit their respective latest learning state used to configure the learning model thereon (deployed thereto in Step 402). The latest learning state, for a given worker node, may encompass non-default value(s) for one or more factors (e.g., weights, weight gradients, and/or weight gradient learning rates) pertinent to the automatic improvement (or “learning”) of the learning model thereon through experience.

In Step 418, in response to the data shift instruction(s) (issued in Step 416), local data adjusted learning state is received from each worker node of the worker node subset (identified in Step 414). In one embodiment of the invention, the local data adjusted learning state from a given worker node may represent learning state optimized based on (or using) the local data respectively collected and/or stored on the given worker node.

In Step 420, an aggregated learning state is obtained. That is, in one embodiment of the invention, the various local data adjusted learning states (received in Step 418) may be reduced to derive the aggregated learning state using one or more aggregation functions (e.g., averaging, etc.). Thereafter, in Step 422, a new learning model is configured with/using the aggregated learning state (obtained in Step 420). In one embodiment of the invention, the new learning model may be of the same paradigm (e.g., neural network, support vector machine, decision tree, etc.) as that of the learning model (deployed in Step 402). Subsequently, the process proceeds to Step 402, where the new learning model (configured in Step 422) is deployed to various worker nodes. The new learning model may replace the previous learning model on the various worker nodes (deployed thereto in a previous iteration of Step 402).

FIG. 5 shows an exemplary computing system in accordance with one or more embodiments of the invention. The computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a central processing unit (CPU) and/or a graphics processing unit (GPU). The computing system (500) may also include one or more input devices (510), such as a touchscreen, keyboard, mouse, microphone, touchpad, electronic pen, or any other type of input device. Further, the communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

In one embodiment of the invention, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for adaptive distributed learning model optimization, comprising:
receiving, by a worker node and from a central node, a first learning model configured with an initial learning state;
making a first determination that a first data shift has transpired;
issuing, based on the first determination, a first data shift notice to the central node;
receiving, in response to issuing the first data shift notice, a first data shift instruction from the central node; and
adjusting, based on the first data shift instruction, the initial learning state through optimization of the first learning model using local data to obtain a second learning model configured with local data adjusted learning state.

2. The method of claim 1, wherein making the first determination, comprises:
generating a first local data distribution reflective of recently collected local data;
obtaining a second local data distribution reflective of historical local data;
computing a distribution distance between the first local data distribution and the second local data distribution; and
determining that the distribution distance exceeds a distribution distance threshold.

3. The method of claim 1, further comprising:
selecting a feature set portion of the local data; and
processing the feature set portion using the first learning model and the second learning model to respectively predict a first value of a storage array performance metric and a second value of the storage array performance metric,
wherein the second value is a more accurate prediction of the storage array performance metric than the first value.

4. The method of claim 3, wherein the feature set portion comprises worker node storage array telemetry and worker node configuration state.

5. The method of claim 1, further comprising:
making a second determination that a second data shift has transpired;
issuing, based on the second determination, a second data shift notice to the central node;
receiving, in response to issuing the second data shift notice, a second data shift instruction from the central node; and
transmitting, based on the second data shift instruction, the local data adjusted learning state to the central node.

6. The method of claim 5, wherein the first data shift instruction is received based on a data shift counter, maintained by the central node, falling short of a data shift counter threshold, wherein the second data shift instruction is received based on the data shift counter at least satisfying the data shift counter threshold.

7. The method of claim 6, wherein the data shift counter threshold reflects a predefined percentage of a set of worker nodes in a network, wherein the set of worker nodes comprises the worker node.

8. The method of claim 5, further comprising:
receiving, from the central node and in response to transmitting the local data adjusted learning state, a third learning model configured with aggregated learning state,
wherein the aggregated learning state is derived from a set of local data adjusted learning states comprising the local data adjusted learning state.

9. The method of claim 8, wherein the set of local data adjusted learning states further comprises other local data adjusted learning state transmitted to the central node by other worker nodes in a network.

10. The method of claim 9, wherein the central node, the worker node, and the other worker nodes participate in federated learning to comply with local data privacy concerns.

11. A non-transitory computer readable medium (CRM) comprising computer readable program code, which when executed by a computer processor on a worker node, enables the computer processor to:
receive, from a central node, a first learning model configured with an initial learning state;
make a first determination that a first data shift has transpired;
issue, based on the first determination, a first data shift notice to the central node;
receive, in response to issuing the first data shift notice, a first data shift instruction from the central node; and
adjust, based on the first data shift instruction, the initial learning state through optimization of the first learning model using local data to obtain a second learning model configured with local data adjusted learning state.

12. The non-transitory CRM of claim 11, comprising computer readable program code to make the first determination, which when executed by the computer processor on the worker node, enables the computer processor to:
generate a first local data distribution reflective of recently collected local data;
obtain a second local data distribution reflective of historical local data;
compute a distribution distance between the first local data distribution and the second local data distribution; and
determine that the distribution distance exceeds a distribution distance threshold.

13. The non-transitory CRM of claim 11, comprising computer readable program code, which when executed by the computer processor on the worker node, further enables the computer processor to:
select a feature set portion of the local data; and
process the feature set portion using the first learning model and the second learning model to respectively predict a first value of a storage array performance metric and a second value of the storage array performance metric,
wherein the second value is a more accurate prediction of the storage array performance metric than the first value.

14. The non-transitory CRM of claim 13, wherein the feature set portion comprises worker node storage array telemetry and worker node configuration state.

15. The non-transitory CRM of claim 11, comprising computer readable program code, which when executed by the computer processor on the worker node, further enables the computer processor to:
make a second determination that a second data shift has transpired;
issue, based on the second determination, a second data shift notice to the central node;
receive, in response to issuing the second data shift notice, a second data shift instruction from the central node; and
transmit, based on the second data shift instruction, the local data adjusted learning state to the central node.

16. The non-transitory CRM of claim 15, wherein the first data shift instruction is received based on a data shift counter, maintained by the central node, falling short of a data shift counter threshold, wherein the second data shift instruction is received based on the data shift counter at least satisfying the data shift counter threshold.

17. The non-transitory CRM of claim 16, wherein the data shift counter threshold reflects a predefined percentage of a set of worker nodes in a network, wherein the set of worker nodes comprises the worker node.

18. The non-transitory CRM of claim 17, comprising computer readable program code, which when executed by the computer processor on the worker node, further enables the computer processor to:
receive, from the central node and in response to transmitting the local data adjusted learning state, a third learning model configured with aggregated learning state,
wherein the aggregated learning state is derived from a set of local data adjusted learning states comprising the local data adjusted learning state.

19. The non-transitory CRM of claim 18, wherein the set of local data adjusted learning states further comprises other local data adjusted learning state transmitted to the central node by other worker nodes in a network.

20. The non-transitory CRM of claim 19, wherein the central node, the worker node, and the other worker nodes participate in federated learning to comply with local data privacy concerns.
